(19) United States
(12) Patent Application Publication
(10) Pub. No.: US 2026/0148138 A1
(43) Pub. Date: May 28, 2026

(54) INFORMATION PROCESSING DEVICE, DISPLAY METHOD, AND STORAGE MEDIUM

(71) Applicant: NEC Corporation, Tokyo (JP)

(72) Inventors: Akira KITAOKA, Tokyo (JP); Yuzuru OKAJIMA, Tokyo (JP); Yoichi SASAKI, Tokyo (JP); Rin TAKANO, Tokyo (JP); Taichi HIRANO, Tokyo (JP)

(73) Assignee: NEC Corporation, Tokyo (JP)

(21) Appl. No.: 19/372,343

(22) Filed: Oct. 29, 2025

(30) Foreign Application Priority Data
Nov. 25, 2024 (JP) 2024-204820

(51) Int. Cl. G06N 20/00

(52) U.S. Cl. CPC G06N 20/00

(57) ABSTRACT

The information processing device 1Y mainly includes a route calculation means 16Y and a display control means 17Y. The route calculation means 16Y is configured to determine, from first information representing a feature value of a first event and second information representing the feature value of a second event different from the first event, a route from the first information to the second information in such a way that an evaluation value obtained by evaluating energy of the route decreases. The display control means 17Y is configured to display information related to the determined route on a display device.

### INCORPORATION BY REFERENCE

This application is based upon and claims the benefit of priority from Japanese Patent Application No. 2024-204820, filed on Nov. 25, 2024, the disclosure of which is incorporated herein in its entirety by reference.

### TECHNICAL FIELD

The present disclosure relates to a technical field of an information processing device and a display method, and a storage medium.

### BACKGROUND

Prediction on input data representing a case by using a machine learning model has been performed in various fields. In relation to this, generation of a proposed modification of the input data for changing the prediction by the machine learning model has also been performed. For example, Patent Literature 1 describes generation of a proposed modification of input data that makes it possible to obtain desired prediction.

### CITATION LIST

### Patent Literature

Patent Literature 1: WO 2022/034685 A1

### SUMMARY

When only information indicating an improved final state is presented as the proposed modification of the input data that makes it possible to obtain the desired prediction, there is a problem that it is difficult for a user to set a route to the final state in a case where a deviation from a current state is large.

In view of the problem described above, an object of the present disclosure is to provide an information processing device, a display method, and a program capable of supporting a user in such a way as to facilitate setting a route to a final state while suppressing a calculation load.

In an example aspect of the present disclosure, there is provided an information processing device including:
a route calculation means for determining, from first information representing a feature value of a first event and second information representing the feature value of a second event different from the first event, a route from the first information to the second information in such a way that an evaluation value obtained by evaluating energy of the route decreases; and
a display control means for displaying information related to the determined route on a display.

In an example aspect of the present disclosure, there is provided a display method including:
determining, from first information representing a feature value of a first event and second information representing the feature value of a second event different from the first event, a route from the first information to the second information in such a way that an evaluation value obtained by evaluating energy of the route decreases; and
displaying information related to the determined route on a display.

In an example aspect of the present disclosure, there is provided a program executed by a computer, the program causing the computer to:
determine, from first information representing a feature value of a first event and second information representing the feature value of a second event different from the first event, a route from the first information to the second information in such a way that an evaluation value obtained by evaluating energy of the route decreases; and
display information related to the determined route on a display.

An example advantage according to the present disclosure is to support a user in such a way as to facilitate setting a route from a first event to a second event while suppressing a calculation load.

### BRIEF DESCRIPTION OF THE DRAWINGS

FIG. 1 illustrates a configuration of an information processing system.

FIG. 2 schematically illustrates a relationship between an input case and a modified case and a route.

FIG. 3 illustrates the hardware configuration of the information processing device.

FIG. 4 is an example of functional blocks of the processor of the information processing device.

FIG. 5 illustrates an example of a flowchart executed by the information processing device.

FIG. 6 is an example of a graph representing transitions of the Lagrangian function and the feature value from the input case to the modified case.

FIG. 7 is an example of a block configuration diagram of the functional input unit in a case where the route determination based on the Riemannian metric is performed.

FIG. 8 is an example of a block configuration diagram of the functional input unit in a case where the function needed for design of the Riemannian metric is determined.

FIG. 9 is an example of a graph representing transitions of a prediction result by the prediction model and the feature value from the input case to the modified case.

FIG. 10 is an example of a graph representing the information related to the route from the input case to the modified case.

FIG. 11 is a first display example representing the calculation result of the route.

FIG. 12 is a second display example representing the calculation result of the route.

FIG. 13 is a third display example representing the calculation result of the route.

FIG. 14 illustrates the configuration of the information processing device.

FIG. 15 illustrates functional blocks of the information processing device.

FIG. 16 is an example of a flowchart indicative of the procedure of the process executed by the information processing device.

FIG. 17 illustrates functional blocks of the information processing device.

FIG. 18 is an example of a flowchart indicative of the procedure of the process executed by the information processing device.

### EXAMPLE EMBODIMENT

Hereinafter, example embodiments of an information processing device, a display method, and a program will be described with reference to the drawings.

### First Example Embodiment

### (1) System Configuration

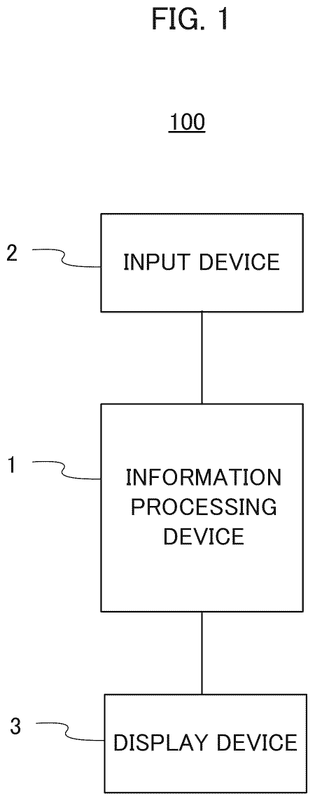

FIG. 1 illustrates a configuration of an information processing system 100. The information processing system 100 performs prediction on a case including a plurality of feature values (that is, features), calculates a route to the case modified to improve such prediction, and displays information related to the calculated route. The information processing system 100 mainly includes an information processing device 1, an input device 2, and a display device 3. Hereinafter, a case used for prediction is referred to as an “input case”, and the case modified to improve the prediction is also referred to as a “modified case”.

The information processing device 1 calculates a route from an input case to a modified case based on information supplied from the input device 2, and displays information related to the calculated route on the display device 3. The information processing device 1 performs data communication with each of the input device 2 and the display device 3 via a communication network or by wireless or wired direct communication.

The input device 2 is an interface that receives a user's input that is an external input, and corresponds to, for example, a touch panel, a button, a keyboard, and an audio input device. The input device 2 supplies information generated based on the user's input to the information processing device 1.

The display device 3 is, for example, a display or a projector, and performs predetermined display based on display information supplied from the information processing device 1.

The configuration of the information processing system 100 illustrated in FIG. 1 is an example, and various changes may be made to the configuration. For example, the input device 2 and the display device 3 may be integrally configured. In this case, the input device 2 and the display device 3 may be configured as a tablet terminal integrated with the information processing device 1. The information processing device 1 may be connected to a sound output device such as a speaker that outputs sound or may incorporate the sound output device, and output information by sound. The information processing device 1 may include a plurality of devices. In this case, the plurality of devices constituting the information processing device 1 exchanges information needed for executing processing allocated in advance between the plurality of devices.

For example, the information processing system 100 is suitably used for an application in which a proposed modification (including a proposed improvement) to a state of a subject such as a customer is indicated along with a route of the state to the proposed modification in fields such as loan screening, marketing, medical examination, and robotics. That is, the information processing system 100 is suitably used for recourse or counterfactual explanation.

Specifically, in the example of the loan screening, it is used to determine a route to a proposed modification for a problem of how to modify the state in order that a low probability of bankruptcy of a machine learning model is output. In the example of the marketing, it is used to determine a route to a proposed modification for a problem of how to modify the state in order to increase a purchase amount. In the example of the medical examination, it is used to determine a route to a proposed modification for a problem of how to make a modification in order to improve a health state. In the example of the robotics, it is used to determine a route to a proposed modification for a problem of how to modify the state in order to improve a trajectory of a robot.

In general, when a goal is too large, it is difficult to set a route, and when a goal is divided into small parts, it is easy to set a route, and therefore, there is a need to know a route to a modified case. For example, in a case where it is desired to achieve the probability of bankruptcy of 10%, it is easy for a user to set a route by setting a first goal to achieve the probability of bankruptcy of equal to or less than 50%, setting a second goal to achieve the probability of bankruptcy of equal to or less than 30%, and setting a final goal to achieve the probability of bankruptcy of equal to or less than 10%. In such a case, by calculating a route and presenting information related to the route to the user, the information processing system 100 can suitably support the approach of achieving the goal by setting the goals obtained by the division into small parts as described above.

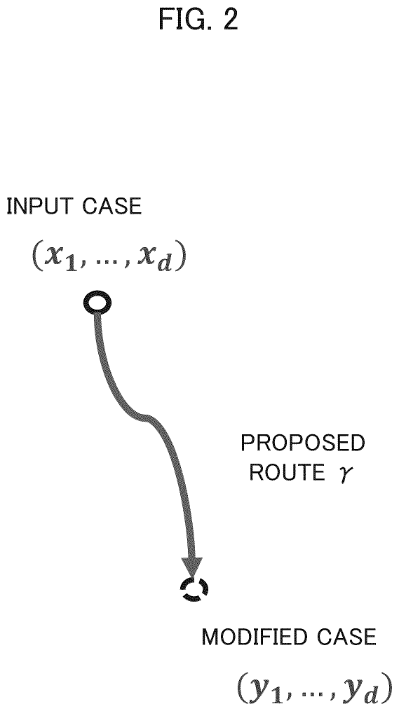

FIG. 2 is a diagram schematically illustrating a relationship between an input case and a modified case and a route proposed by the information processing device 1. In the example of FIG. 2, “d” (d is an integer of 1 or more) types of feature values are used, and a state of the input case is represented by d types of feature values “(x₁, . . . , x_{d})”, and a state of the modified case is represented by d types of feature values “(y₁, . . . , y_{d})”. The information processing device 1 determines a route “γ” of a feature space from the feature values (x₁, . . . , x_{d}) representing the state of the input case to the feature values (y₁, . . . , y_{d}) representing the state of the modified case. Details of a method for determining the route γ will be described later. The input case is an example of a first event, and the feature values “(x₁, . . . , x_{d})” of the input case are examples of first information. The modified case is an example of a second event, and the feature values “(y₁, . . . , y_{d})” of the modified case are examples of second information.

### (2) Hardware Configuration

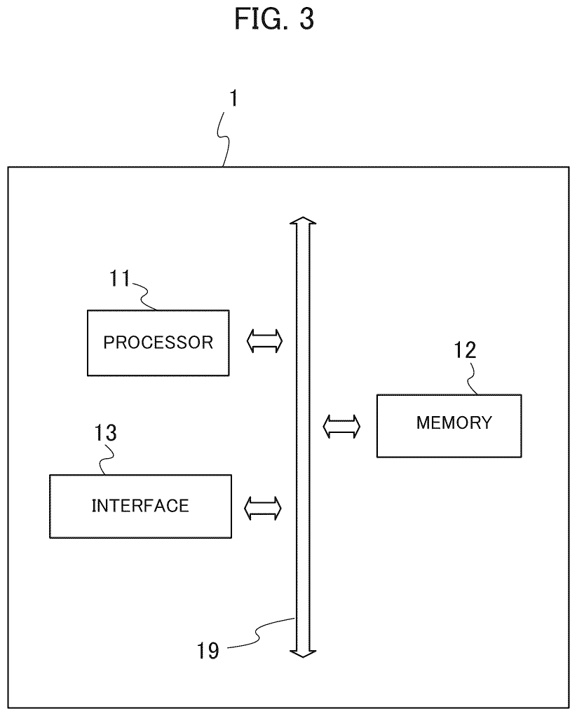

FIG. 3 illustrates the hardware configuration of the information processing device 1. The information processing device 1 includes, as hardware, a processor 11, a memory 12, and an interface 13. The processor 11, the memory 12, and the interface 13 are connected to one another via a data bus 19.

The processor 11 execute a program stored in the memory 12 to perform a predetermined process. The processor 11 is one or more processors such as a CPU (Central Processing Unit), a GPU (Graphics Processing Unit), and a TPU (Tensor Processing Unit). The processor 11 may be configured by plural processors. The processor 11 is an example of a computer.

The memory 12 is configured by volatile or non-volatile memories such as a RAM (Random Access Memory) and a ROM (Read Only Memory). The memory 12 stores a program for the information processing device 1 to perform various processes.

The memory 12 also stores information needed for the information processing device 1 to perform route calculation and display control of information related to a route, other than in the program. For example, the memory 12 stores model information of a prediction model that performs prediction from an input case. The prediction model is a machine learning model that outputs prediction data when case data is input. Therefore, the prediction model is generated by machine learning using learning data including the case data and result data prepared in advance. For example, the case data is data (that is, feature data) representing a plurality of types of feature values such as revenue, liabilities, labor costs, and fixed costs, representing a management state of business, and the result data is data representing a result of management, such as whether there has been bankruptcy or a calculated probability of bankruptcy. By performing the machine learning using such learning data, the prediction model is generated in such a way as to output the prediction data that is the probability of bankruptcy from the case data including the plurality of pieces of feature data representing the management situation. The prediction model is not limited 30) to one that predicts the probability of bankruptcy, and may be one that predicts an optional index quantitatively representing quality in each field such as the loan screening, the marketing, the medical examination, and the robotics.

The memory 12 is used as a working memory, and temporarily stores information and the like acquired from any external device. The external device in this case may be a storage device, such as a hard disk, connected to or incorporated in the information processing device 1 or may be a storage medium as a flash memory. The external device may be a server device configured to perform a data communication with the information processing device 1. The server device in this case may be configured by plural server devices. The program executed by the information processing device 1 may be stored a storage medium other than the memory 12.

The interface 13 is one or more interfaces for electrically connecting the information processing device 1 and another device. These interfaces may include a wireless interface such as a network adapter for wirelessly transmitting and receiving data to and from the another device, or may include a hardware interface for connecting to the another device by a cable or the like.

A hardware configuration of the information processing device 1 is not limited to the configuration illustrated in FIG. 3. For example, the information processing device 1 may include at least one of the display device 3 or the input device 4. The information processing device 1 may be connected to or may incorporate a sound output device such as a speaker.

### (3) Processing Overview

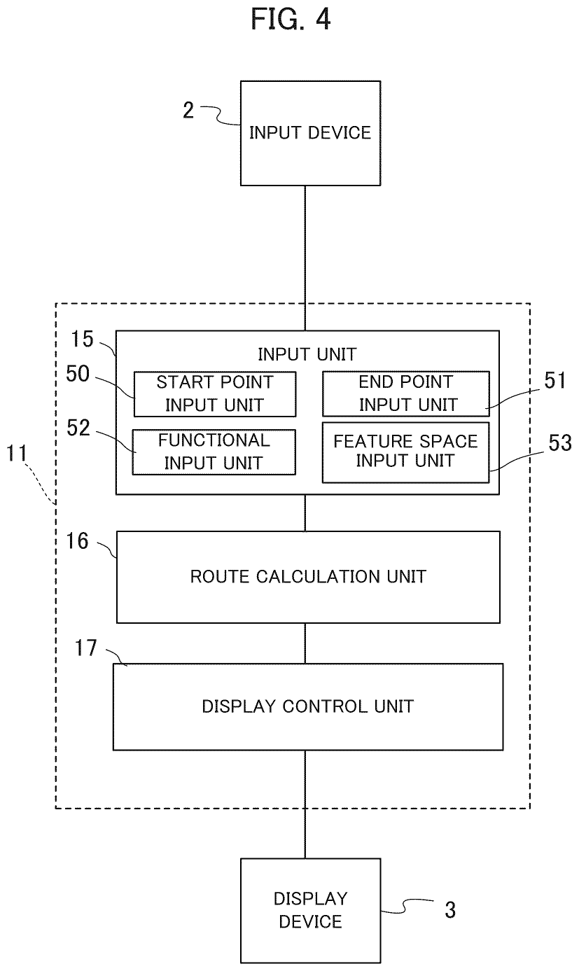

FIG. 4 is an example of functional blocks of the processor 11 of the information processing device 1. The processor 11 functionally includes an input unit 15, a route calculation unit 16, and a display control unit 17.

The input unit 15 generates information to be input to the route calculation unit 16 based on information supplied from the input device 2 or information stored in advance in the memory 12. The input unit 15 includes a start point input unit 50, an end point input unit 51, a functional input unit 52, and a feature space input unit 53. The start point input unit 50 acquires input case data that is data related to a start point of a route (that is, an input case), and supplies the input case data to the route calculation unit 16. The end point input unit 51 acquires modified case data that is data related to an end point of the route (that is, a modified case), and supplies the modified case 30) data to the route calculation unit 16. The functional input unit 52 acquires information specifying a functional (that is, an action functional) used to determine the route by minimizing the functional, and supplies the acquired information to the route calculation unit 16. The feature space input unit 53 acquires information specifying a manifold (figure) determining a feature space that is a space of d types of feature values, and supplies the acquired information to the route calculation unit 16. The feature space input unit 53 is not an essential configuration, and does not have to be present in a case where, for example, the feature space is based on a Euclidean space.

The route calculation unit 16 calculates the route based on the information supplied from the input unit 15. In this case, the route calculation unit 16 minimizes the action functional and determines the route that minimizes the action functional based on the input case data, the modified case data, and the information specifying the action functional and the feature space. The route calculation unit 16 supplies a calculation result of the route to the display control unit 17.

The display control unit 17 performs display control of the display device 3 by generating display information based on the calculation result of the route generated by the route calculation unit 16 and supplying the generated display information to the display device 3. Specific processing of the display control unit 17 will be described later with reference to a display example.

Here, each component of the input unit 15, the route calculation unit 16, and the display control unit 17 can be implemented by, for example, the processor 11 executing a program. Each component may also be achieved by recording a necessary program in an optional nonvolatile storage medium and installing the program as necessary. At least a part of these components is not limited to be achieved by software by a program, and may be achieved by a combination of any of hardware, firmware, and software, or the like. At least a part of these components may be achieved using, for example, a user-programmable integrated circuit such as a field-programmable gate array (FPGA) or a microcontroller. In this case, a program including the above components may be achieved by using the integrated circuit. At least a part of the components may include an application specific standard produce (ASSP), an application specific integrated circuit (ASIC), or a quantum processor (quantum computer control chip). In this manner, the components may be achieved by various types of hardware. The same applies to other example embodiments described later. These components may also be achieved by, for example, cooperation of a plurality of computers by using a cloud computing technology or the like.

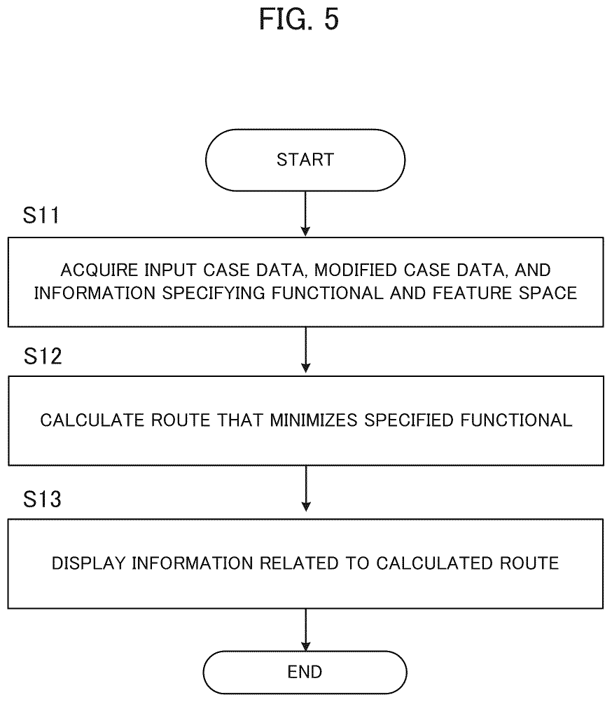

FIG. 5 illustrates an example of a flowchart executed by the information processing device 1. First, the input unit 15 of the information processing device 1 acquires input case data, modified case data, and information specifying an action functional and a feature space (step S11). In this case, the input unit 15 may acquire these pieces of information by receiving a user's input by the input device 2, or may read these pieces of information from the memory 12 in a case where these pieces of information are stored in the memory 12 in advance as initial information. Next, the route calculation unit 16 of the information processing device 1 calculates a route that minimizes the specified action functional (step S12). The display control unit 17 of the information processing device 1 then displays information related to the calculated route on the display device 3 (step S13).

### (4) Details of Route Determination Method

Next, details of route determination by the route calculation unit 16 will be described.

### (4-1) Route Determination Based on Lagrangian Function

The route calculation unit 16 calculates, by using a Lagrangian function “L”, a route γ that minimizes an action functional “I(γ)” indicated in the following Expression (1). A value of the action functional I(γ) relates to an “evaluation value obtained by evaluating complexity of a route from the first information to the second information”.

$$\begin{matrix}[ Expression 1 ] & \\ {arg min}_{γ : [ 0 , T ] \to M} I ( γ ) := {\int }_{0}^{T} L ( t , γ , \dot{γ} ) dt & ( 1 )\end{matrix}$$

$$subject to γ ( 0 ) ∈ {X}^{( 0 )} , γ ( T ) ∈ {X}^{( T )}$$

Here, “γ” represents a route on a feature space of a feature value. “M” is a manifold or a figure representing the feature space of the feature value, and is, for example, the Euclidean space. In addition, “t” represents a parameter, and a parameter related to input case is “t=0”, and a parameter related to modified case is “t=T”. Hereinafter, it is assumed that “T=1” unless otherwise specified. “X⁽⁰⁾” represents a set of start points of the route γ, and “X⁽⁰⁾⊂M” holds. “X^{(T)}” represents a set of end points of the route γ, and “X^{(T)}⊂M” holds.

In this manner, the action functional “I(Y)” can be represented by an integral of a Lagrangian function L(t, γ, γ′) having, as arguments, t, γ, and γ′ (dot notation using a dot symbol is adopted in each expression) that is a first order derivative of γ. The Lagrangian function L may be designed to be a function having, as the argument, a second or higher order derivative of γ, not limited to the first order derivative of γ. The specific Lagrangian function L is determined by the functional input unit 52.

The Lagrangian function L may be obtained by machine learning by deep learning using a neural network. A specific example of machine learning the Lagrangian function using an architecture of the neural network is disclosed in, for example, the following document.

“LAGRANGIAN NEURAL NETWORKS” arXiv: 2003.04630v2 [cs.LG] 30 Jul. 2020

The route calculation unit 16 may then reduce an optimization problem indicated in Expression (1) to nonlinear programming and solve the optimization problem, or reduce the optimization problem to differential dynamic programming and solve the optimization problem. Examples of the nonlinear programming described above include a primal-dual interior point method, a gradient method, a genetic algorithm, a local search, and an iterative improvement method. These algorithms are implemented by, for example, ALGLIB, NLopt, SciPy, IPOPT, and CasADi. As an example of the differential dynamic programming described above, a method described in the following document may be used.

Z. Xie, C K. Liu, and K. Hauser, Differential dynamic programming with nonlinear constraints, 2017 IEEE international conference on robotics and automation (ICRA), 2017, pp. 695-702.

In order to approximately solve Expression (1), the route calculation unit 16 approximates an integral of the action functional with a point cloud by a collocation method, for example. In this case, the route calculation unit 16 solves the following Expression (2) obtained by deforming Expression (1).

$$\begin{matrix}[ Expression 2 ] & \\ {arg min}_{γ : [ 0 , T ] \to M} \frac{1}{N} {\sum }_{n = 0}^{N - 1} L ( {t}_{n} , γ ( {t}_{n} ) , \dot{γ} ( {t}_{n} ) ) & ( 2 )\end{matrix}$$

$$subject to γ ( 0 ) ∈ {X}^{( 0 )} , γ ( T ) ∈ {X}^{( T )} , {t}_{n} = \frac{nT}{N}$$

A selected point may be a left end or a midpoint of each section obtained by dividing a value range “0≤t≤1” of the parameter t into N sections. The route calculation unit 16 may perform the approximation by using a Simpson's rule. The route calculation unit 16 then determines the route γ by solving Expression (2) by the nonlinear programming or the differential dynamic programming described above.

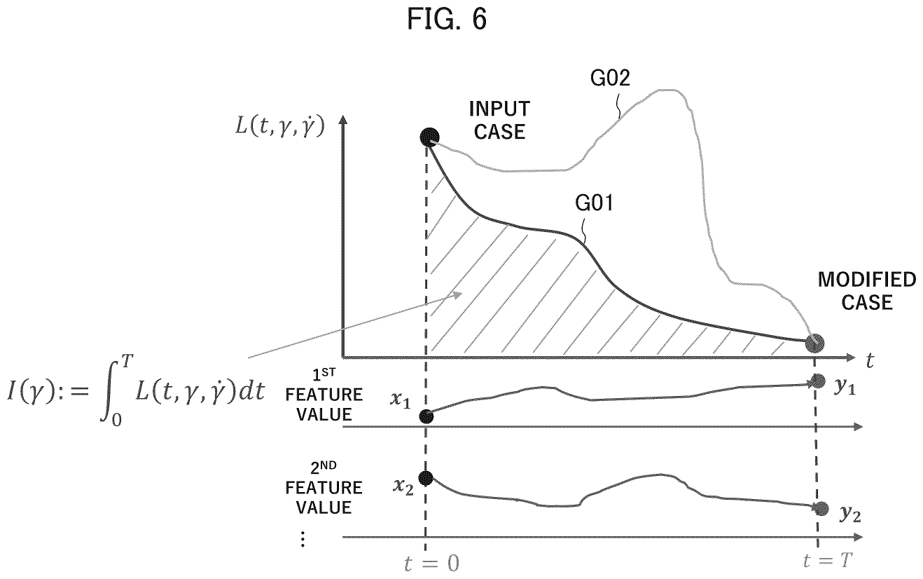

FIG. 6 is an example of a graph representing transitions of the Lagrangian function L and the feature value from the input case to the modified case. In FIG. 6, it is assumed that d types of feature values are used, and feature values at the time of the input case are “(x₁, . . . , x_{d})”, and feature values at the time of the modified case are “(y₁, . . . , y_{d})”. A graph G01 indicates a transition of a value of the Lagrangian function L of a route that minimizes the action functional I in Expression (1), and a graph G02 indicates an example of a transition of a value of the Lagrangian function L of a route that does not minimize the action functional I.

Here, the action functional indicated in the graph G01 relates to an area (that is, a hatched region in FIG. 6) sandwiched between the graph G01 and a horizontal axis in a section where the parameter t is 0 to T. The route calculation unit 16 determines the route γ that minimizes the area. Since an area sandwiched between the graph G02 and the horizontal axis in the section where the parameter t is 0 to T is clearly larger than the area sandwiched between the graph G01 and the horizontal axis, and does not minimize the action functional I, the route specified by the graph G02 does not become the route γ determined by the route calculation unit 16.

### (4-2) Route Determination Based on Riemannian Metric

In a preferred example in a minimization problem of the action functional I of Expression (1), the route calculation unit 16 is only required to calculate the shortest route related to Riemannian metric. For example, in a case where the shortest route based on a length of the Riemannian metric is calculated, the route calculation unit 16 converts the Lagrangian function L indicated in Expression (1) into the following Expression (3) by using an inner product “g”.

$$\begin{matrix}[ Expression 3 ] & \\ L ( t , γ , \dot{γ} ) = \sqrt{{g}_{γ ( t )} ( \dot{γ} , \dot{γ} )} & ( 3 )\end{matrix}$$

Here, the Riemannian metric refers to one for which an inner product gₓ is determined for each point x∈M. In a case where the inner product gₓ is a canonical inner product, the Riemannian metric relates to Euclidean metric, and the length of the route is a Euclidean distance. In a case where “v” is a vector, “A” is a matrix, and the inner product “gₓ(v, v)=(v, Av)” holds, the length of the route γ is a Mahalanobis distance. This metric is hereinafter also referred to as Mahalanobis metric.

The Riemannian metric may be obtained by machine learning. In this case, Fisher information may be determined by the machine learning, or the Mahalanobis distance may be determined by the machine learning. The Riemannian metric may also be obtained by deep learning using a neural network.

Here, when “gₓ(v, v)=f(x)²∥v∥₂²” holds, the following Expression (4) holds.

$$\begin{matrix}[ Expression 4 ] & \\ {\int }_{0}^{T} \sqrt{{g}_{γ ( t )} ( \dot{γ} , \dot{γ} )} dt = {\int }_{0}^{T} f ( γ ) {‖ \dot{γ} ‖}_{2} dt = {\int }_{γ} f ( x ) ds & ( 4 )\end{matrix}$$

In this case, the Lagrangian function L of Expression (1) is represented by the following Expression (5).

$$\begin{matrix}[ Expression 5 ] & \\ L ( t , γ , \dot{γ} ) = f ( γ ) {‖ \dot{γ} ‖}_{2} & ( 5 )\end{matrix}$$

In Expressions (4) and (5), ∥γ∥² represents an L2 norm of the route γ, but may be the Mahalanobis distance. A function “f” is a function that represents a prediction model and has the feature value as an argument. The function f may be a probability distribution, a probability, a utility function, or an error function. The function f may also be an existing basic model or a function obtained by performing machine learning. Examples of the machine learning of the function f include XGBoost, LightGBM, and deep learning using a neural network. The function f does not have to be a smooth function. In a case where the function f is not smooth, the function f may be approximated by a smooth function to perform optimization for obtaining the route γ.

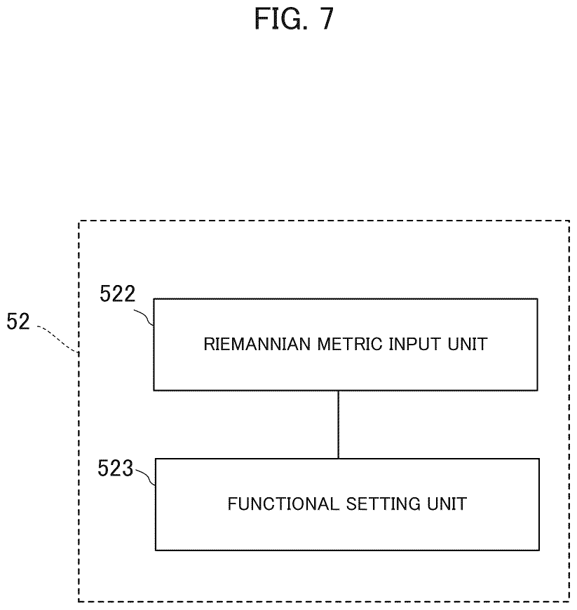

FIG. 7 is an example of a block configuration diagram of the functional input unit 52 in a case where the route determination based on the Riemannian metric is performed. The functional input unit 52 includes a Riemannian metric input unit 522 and a functional setting unit 523. In this case, the Riemannian metric input unit 522 acquires information specifying the inner product g by referring to the memory 12 or from the input device 2. The functional setting unit 523 then sets the functional indicated in Expression (1) based on the information specifying the inner product g, which is acquired by the Riemannian metric input unit 522, and Expression (3).

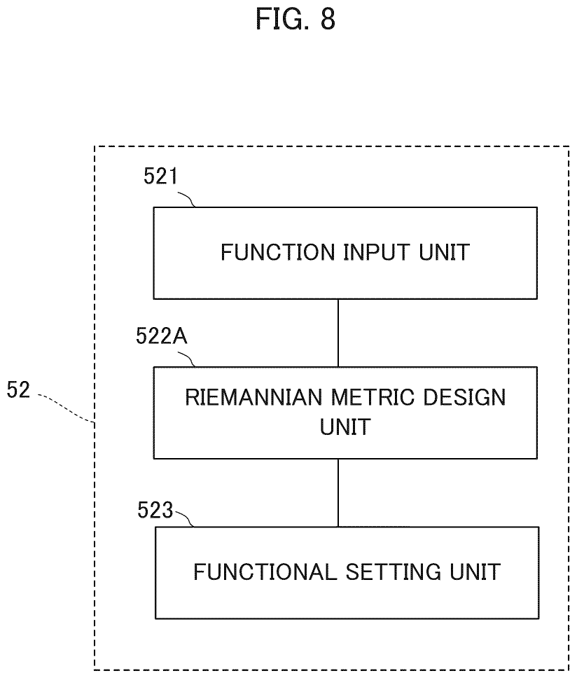

FIG. 8 is an example of a block configuration diagram of the functional input unit 52 in a case where the function f needed for design of the Riemannian metric is determined. The functional input unit 52 includes a function input unit 521, a Riemannian metric design unit 522A, and the functional setting unit 523. In this case, the function input unit 521 acquires information specifying the function f by referring to the memory 12 or from the input device 2. The Riemannian metric design unit 522A then acquires the information specifying the function f from the function input unit 521, and designs the Riemannian metric related to the inner product g based on the information specifying the function f. In this case, for example, information indicating a relationship between the function f and the inner product g (for example, “gₓ(v, v)=f(x)²∥v∥₂²”) is stored in advance in the memory 12 or the like, and the Riemannian metric design unit 522A determines the inner product g from the specified function f by referring to the information. The functional setting unit 523 then sets the Lagrangian function L used for the minimization problem of the action functional I of Expression (1) based on the Riemannian metric designed by the Riemannian metric design unit 522A.

The route calculation unit 16 may determine the route based on energy of the Riemannian metric instead of determining the route based on the length of the Riemannian metric using Expression (3).

In a case where the route is determined based on the energy of the Riemannian metric, the route calculation unit 16 converts the Lagrangian function L indicated in Expression (1) into the following Expression (6) by using the inner product g.

$$\begin{matrix}[ Expression 6 ] & \\ L ( t , γ , \dot{γ} ) = {g}_{γ ( t )} ( \dot{γ} , \dot{γ} ) & ( 6 )\end{matrix}$$

Here, in a case where the integral of the action functional of Expression (1) is approximated by the point cloud by the collocation method, the route calculation unit 16 solves the following Expression (7) as the minimization problem for determining the route γ based on the energy of the Riemannian metric.

$$\begin{matrix}[ Expression 7 ] & \\ arg {min}_{γ} \frac{1}{N} {\sum }_{n = 0}^{N - 1} g ( \dot{γ} ( {t}_{n} ) , \dot{γ} ( {t}_{n} ) ) & ( 7 )\end{matrix}$$

$$subject to γ ( 0 ) = {x}^{( 0 )} , γ ( T ) ∈ {X}^{( T )} , {t}_{n} = nT / N$$

When “gₓ(v, v)=f(x)²∥v∥₂²” holds, Expression (6) is converted into the following Expression (8).

$$\begin{matrix}[ Expression 8 ] & \\ L ( t , γ , \dot{γ} ) = {f ( γ )}^{2} {‖ \dot{γ} ‖}_{2}^{2} & ( 8 )\end{matrix}$$

Here, in a case where the route is determined based on the length of the Riemannian metric using Expression (3) and a case where the route is determined based on the energy of the Riemannian metric using Expression (6), the same solution is obtained under a condition that the function f that determines the inner product g is smooth. On the other hand, for a calculation amount in calculation after discrete approximation by the collocation method, the calculation is complicated in the case where the route is determined based on the length of the Riemannian metric because square root (root) calculation is performed, whereas the square root calculation does not exist in the case where the route is determined based on the energy of the Riemannian metric. Therefore, a calculation load tends to be lighter in the case where the route is determined based on the energy of the Riemannian metric.

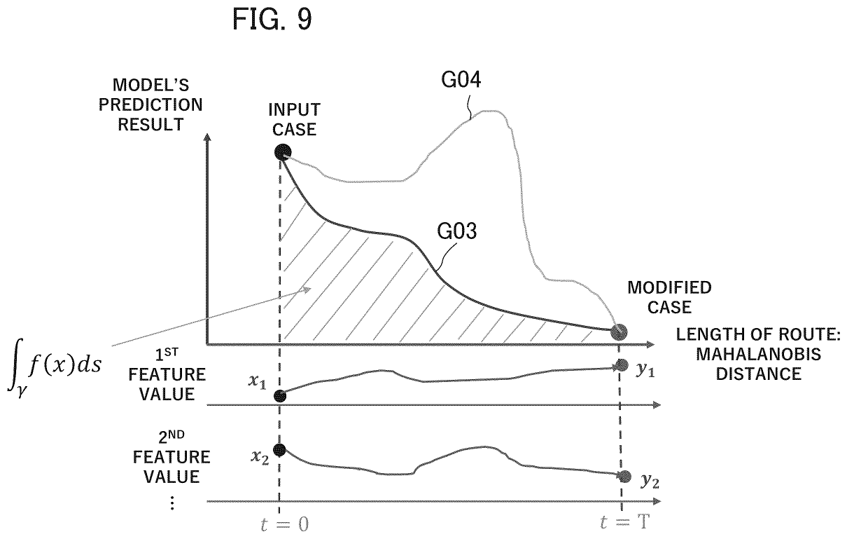

FIG. 9 is an example of a graph representing transitions of a prediction result by the prediction model and the feature value from the input case to the modified case. In FIG. 9, as an example, it is assumed that d types of feature values are used, and feature values at the time of the input case are “(x₁, . . . , x_{d})”, and feature values at the time of the modified case are “(y₁, . . . , y_{d})”. A graph G03 indicates a transition of the prediction result by the prediction model (that is, a value of the function f) of the route γ that minimizes the action functional I in Expression (1), and a graph G04 indicates an example of a transition of a value of the function f of the route that does not minimize the action functional I. A horizontal axis of the graphs G03 and G04 represents the length of the route based on the Mahalanobis distance. The horizontal axis of the graphs G03 and G04 is an example of a first axis related to the length related to a distance of the route, and a vertical axis of the graphs G03 and G04 is an example of a second axis related to a prediction value at a point of the route. The “distance of the route” is only required to be a distance determined from the Riemannian metric, not limited to the Mahalanobis distance. The horizontal axis and the vertical axis of the graphs G03 and G04 form a two-dimensional coordinate space.

Determining the route γ based on the Riemannian metric in the minimization problem of the action functional I indicated in Expression (1) is equivalent to determining the route γ that minimizes an area sandwiched by the graph indicating the prediction result by the prediction model and the horizontal axis in the section where the parameter t is 0 to T. This area is equal to a value obtained by integrating the function f with respect to the length of the route (that is, ∫_{γ}f(x)ds). Since an area sandwiched between the graph G03 and the horizontal axis in the section where the parameter t is 0 to T (that is, the area of a hatched region) is minimized, the route calculation unit 16 determines the route γ specified by the graph G03. On the other hand, since an area sandwiched between the graph G04 and the horizontal axis in the section where the parameter t is 0 to T is clearly larger than the area sandwiched between the graph G03 and the horizontal axis, the route specified by the graph G04 does not become the route γ determined by the route calculation unit 16.

### (4-3) Route Determination in Consideration of Sparsity

The route calculation unit 16 may provide a constraint condition (soft constraint) for outputting a sparse route related to a change from input of the feature value in the minimization problem of the action functional I. In this case, the route calculation unit 16 provides the constraint condition (soft constraint) related to at least one of the change in the feature value or a gradient of the route γ in the minimization problem indicated in Expression (1). As a result, the route calculation unit 16 can determine the sparse route γ.

First, an example in which the constraint condition (soft constraint) related to the change in the feature value is provided will be described. The route calculation unit 16 further adds a regularization term of an L1 norm related to the change in the feature value to the Lagrangian function L indicated in Expression (3), as indicated in the following Expression (9).

$$\begin{matrix}[ Expression 9 ] & \\ L ( t , γ , \dot{γ} ) = \sqrt{{g}_{γ ( t )} ( \dot{γ} , \dot{γ} )} + {λ}_{1} ( t , γ , \dot{γ} ) {‖ γ ( t ) - γ ( 0 ) ‖}_{1} & ( 9 )\end{matrix}$$

The regularization term of the LI norm indicated in Expression (9) relates to the constraint condition related to the change in the feature value. A parameter for adjusting sparsity is represented by “λ₁”. By setting the Lagrangian function in this manner, the route calculation unit 16 can obtain the sparse route related to the change in the feature value from the input while setting the length of the route to the length based on the Riemannian metric.

In the recourse, the sparsity refers to that the number of feature values to be changed is small or a range of the change in the feature values is small. For example, in a case where a proposed modification for lowering a probability of becoming a specific disease is determined in a medical examination, a proposal for changing two feature values of a body weight value and a cholesterol value has the sparsity with the smaller number of feature values to be changed than a proposal for changing five feature values of the body weight value, a white blood cell count, a hemoglobin count, the cholesterol value, and a uric acid value, and thus has higher explainability.

In Expression (9), when “gₓ(v, v)=f(x)²∥v∥₂²” holds, the following Expression (10) holds.

$$\begin{matrix}[ Expression 10 ] & \\ L ( t , γ , \dot{γ} ) = f ( γ ) {‖ \dot{γ} ‖}_{2} + {λ}_{1} ( t , γ , \dot{γ} ) {‖ γ ( t ) - γ ( 0 ) ‖}_{1} & ( 10 )\end{matrix}$$

The route calculation unit 16 may provide the regularization term of the LI norm related to the change in the feature value also in the case where the route is determined based on the energy of the Riemannian metric. In this case, the route calculation unit 16 solves the minimization problem of the action functional I of Expression (1) by using the following Expression (11) obtained by adding the regularization term of the LI norm related to the change in the feature value in the Lagrangian function L based on Expression (6).

$$\begin{matrix}[ Expression 11 ] & \\ L ( t , γ , \dot{γ} ) = {g}_{γ ( t )} ( \dot{γ} , \dot{γ} ) + {λ}_{1} ( t , γ , \dot{γ} ) {‖ γ ( t ) - γ ( 0 ) ‖}_{1} & ( 11 )\end{matrix}$$

In Expression (11), when “gₓ(v, v)=f(x)²∥v∥₂²” holds, the following Expression (12) holds.

$$\begin{matrix}[ Expression 12 ] & \\ L ( t , γ , \dot{γ} ) = {f ( γ )}^{2} {‖ \dot{γ} ‖}_{2}^{2} + {λ}_{1} ( t , γ , \dot{γ} ) {‖ γ ( t ) - γ ( 0 ) ‖}_{1} & ( 12 )\end{matrix}$$

Next, an example in which the constraint condition (soft constraint) related to the gradient of the route γ is provided will be described. The route calculation unit 16 further adds the regularization term of the LI norm related to the gradient of the route γ to the Lagrangian function L indicated in Expression (3), as indicated in the following Expression (13).

$$\begin{matrix}[ Expression 13 ] & \\ L ( t , γ , \dot{γ} ) = \sqrt{{g}_{γ ( t )} ( \dot{γ} , \dot{γ} )} + {λ}_{2} ( t , γ , \dot{γ} ) {‖ \dot{γ} ‖}_{1} & ( 13 )\end{matrix}$$

The regularization term of the L1 norm indicated in Expression (13) relates to the constraint condition related to the gradient of the route γ. A parameter for adjusting the sparsity is represented by “λ₂”. By setting the Lagrangian function in this manner, the route calculation unit 16 can obtain the sparse route γ related to the gradient of the route γ while setting the length of the route to the length based on the Riemannian metric.

Here, in a case where the integral of the action functional I of Expression (1) is approximated by the point cloud by the collocation method, the route calculation unit 16 solves the following Expression (14) as the minimization problem of the action functional I in a case where the route is determined based on the energy of the Riemannian metric. Here, the parameter λ₂ is set to 1.

$$\begin{matrix}[ Expression 14 ] & \\ arg {min}_{γ} \frac{1}{N} {\sum }_{n = 0}^{N - 1} ( g ( \dot{γ} ( {t}_{n} ) , \dot{γ} ( {t}_{n} ) ) + {‖ \dot{γ} ( {t}_{n} ) ‖}_{1} ) & ( 14 )\end{matrix}$$

$$subject to γ ( 0 ) = {x}^{( 0 )} , γ ( T ) ∈ {X}^{( T )} , {t}_{n} = nT / N$$

In Expression (13), when “g. (v, v)=f(x)²∥v∥₂²” holds, the following Expression (15) holds.

$$\begin{matrix}[ Expression 15 ] & \\ L ( t , γ , \dot{γ} ) = f ( γ ) {‖ \dot{γ} ‖}_{2} + {λ}_{2} ( t , γ , \dot{γ} ) {‖ \dot{γ} ‖}_{1} & ( 15 )\end{matrix}$$

The route calculation unit 16 may provide the regularization term of the LI norm related to the gradient of the route γ also in the case where the route is determined based on the energy of the Riemannian metric. In this case, the route calculation unit 16 solves the problem of Expression (1) by using the following Expression (16) obtained by adding the regularization term of the L1 norm related to the gradient of the route γ to Expression (6).

$$\begin{matrix}[ Expression 16 ] & \\ L ( t , γ , \dot{γ} ) = {g}_{γ ( t )} ( \dot{γ} , \dot{γ} ) + {λ}_{2} ( t , γ , \dot{γ} ) {‖ \dot{γ} ‖}_{1} & ( 16 )\end{matrix}$$

Also in this case, in a case where the minimization problem of the action functional I using the energy based on the Riemannian metric is solved, the route calculation unit 16 can obtain the sparse route γ related to the gradient, and can reduce the calculation load.

In Expression (16), when “gₓ(v, v)=f(x)²∥v∥₂²” holds, the following Expression (17) holds.

$$\begin{matrix}[ Expression 17 ] & \\ L ( t , γ , \dot{γ} ) = {f ( γ )}^{2} {‖ \dot{γ} ‖}_{2}^{2} + {λ}_{2} ( t , γ , \dot{γ} ) {‖ \dot{γ} ‖}_{1} & ( 17 )\end{matrix}$$

Next, an example in which both the constraint condition (soft constraint) related to the change in the feature value and the constraint condition (soft constraint) related to the gradient of the route γ are provided will be described.

The route calculation unit 16 adds both the regularization term of the LI norm related to the change in the feature value and the regularization term of the L1 norm related to the gradient of the route γ to the Lagrangian function L indicated in Expression (3), as indicated in the following Expression (18).

$$\begin{matrix}[ Expression 18 ] & \\ L ( t , γ , \dot{γ} ) = \sqrt{{g}_{γ ( t )} ( \dot{γ} , \dot{γ} )} + {λ}_{1} ( t , γ , \dot{γ} ) {‖ γ ( t ) - γ ( 0 ) ‖}_{1} + {λ}_{2} ( t , γ , \dot{γ} ) {‖ \dot{γ} ‖}_{1} & ( 18 )\end{matrix}$$

The regularization term of the LI norm including the parameter A indicated in Expression (18) relates to the constraint condition related to the change in the feature value, and the regularization term of the L1 norm including the parameter 22 relates to the constraint condition related to the gradient of the route γ. By setting the Lagrangian function in this manner, the route calculation unit 16 can obtain the sparse route related to both the change in the feature value and the gradient of the route γ in a case where the minimization problem of the action functional I using the length based on the Riemannian metric is solved.

In Expression (18), when “gₓ(v, v)=f(x)²∥v∥₂²” holds, the following Expression (19) holds.

$$\begin{matrix}[ Expression 19 ] & \\ L ( t , γ , \dot{γ} ) = f ( γ ) {‖ \dot{γ} ‖}_{2} + {λ}_{1} ( t , γ , \dot{γ} ) {‖ γ ( t ) - γ ( 0 ) ‖}_{1} + {λ}_{2} ( t , γ , \dot{γ} ) {‖ \dot{γ} ‖}_{1} & ( 19 )\end{matrix}$$

The route calculation unit 16 may provide both the regularization term of the L1 norm related to the change in the feature value and the regularization term of the LI norm related to the gradient of the route γ also in the case where the route is determined based on the energy of the Riemannian metric. In this case, the route calculation unit 16 solves the problem of Expression (1) by using the following Expression (20) obtained by adding these regularization terms of the L1 norm to Expression (6).

$$\begin{matrix}[ Expression 20 ] & \\ L ( t , γ , \dot{γ} ) = {g}_{γ ( t )} ( \dot{γ} , \dot{γ} ) + {λ}_{1} ( t , γ , \dot{γ} ) {‖ γ ( t ) - γ ( 0 ) ‖}_{1} + {λ}_{2} ( t , γ , \dot{γ} ) {‖ \dot{γ} ‖}_{1} & ( 20 )\end{matrix}$$

Also in this case, in a case where the minimization problem of the action functional I using the energy based on the Riemannian metric is solved, the route calculation unit 16 can obtain the sparse route γ related to both the change in the feature value and the gradient of the route γ, and can reduce the calculation load.

In Expression (20), when “gₓ(v, v)=f(x)²∥v∥₂²” holds, the following Expression (21) holds.

$$\begin{matrix}[ Expression 21 ] & \\ L ( t , γ , \dot{γ} ) = {f ( γ )}^{2} {‖ \dot{γ} ‖}_{2}^{2} + {λ}_{1} ( t , γ , \dot{γ} ) {‖ γ ( t ) - γ ( 0 ) ‖}_{1} + {λ}_{2} ( t , γ , \dot{γ} ) {‖ \dot{γ} ‖}_{1} & ( 21 )\end{matrix}$$

### (5) Display Example

Information related to the route γ displayed by the display control unit 17 based on the calculation result of the route γ by the route calculation unit 16 will be described.

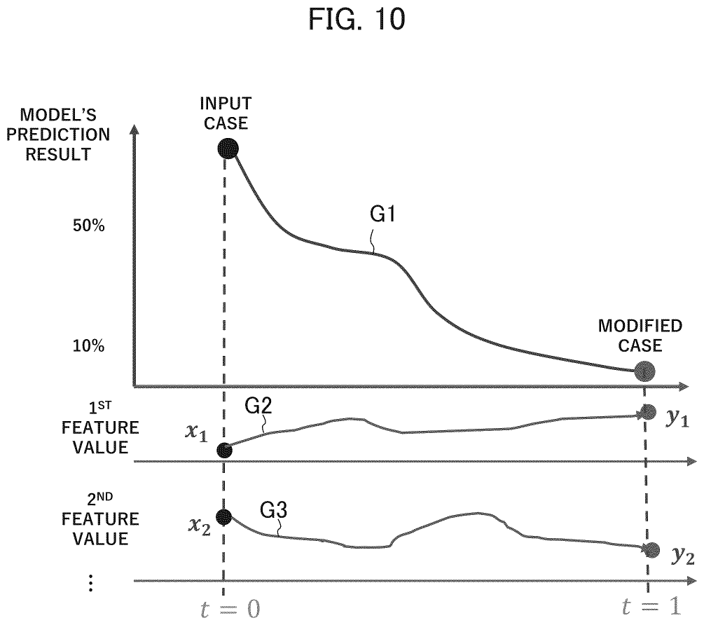

FIG. 10 is an example of a graph representing the information related to the route from the input case to the modified case. FIG. 10 illustrates an example in which the shortest route γ related to the Riemannian metric is calculated based on Expression (3) or (6), and it is assumed that the function f related to the prediction model outputs a percentage of a probability. It is also assumed that the function f performs prediction using d types of feature values as arguments, and feature values at the time of the input case are “(x₁, . . . , x_{d})”, and feature values at the time of the modified case are “(y₁, . . . , y_{d})”.

In each graph illustrated in FIG. 10, “T=1” holds, and the parameter t is changed from 0 to 1 on a horizontal axis. The parameter t relates to the length of the route. A prediction result graph G1 in which the “prediction result of the model” indicating the value of the function f is set as a vertical axis, and feature value graphs G2 and G3 in which a “first feature value” and a “second feature value” representing two types of feature values included in the d types of feature values input to the function f are set as vertical axes are illustrated.

Here, the route calculation unit 16 determines the route γ by solving the minimization problem indicated in Expression (1) based on Expression (3) or (6). The route γ determined by the route calculation unit 16 indicates values of the d types of feature values including the “first feature value” and a “second feature value” at 0≤t≤1, and relates to information represented by the feature value graphs G2 and G3. The route calculation unit 16 or the display control unit 17 calculates the value of the function f at 0≤t≤1 as the “prediction result of the model” based on the values of the d types of feature values at 0≤t≤1. The value of the function f at 0≤t≤1 calculated in this case relates to information represented by the prediction result graph G1.

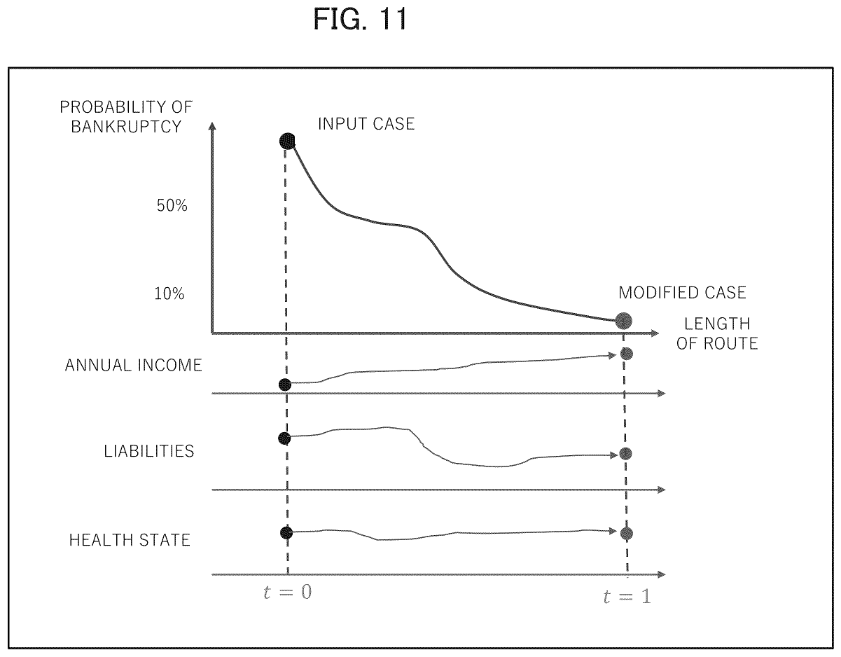

FIG. 11 is a first display example representing the calculation result of the route γ displayed on the display device 3 by the display control unit 17. In a case where the route calculation unit 16 calculates the shortest route γ related to the Riemannian metric, by generating the display information based on the calculation result of the route γ and supplying the generated display information to the display device 3, the display control unit 17 causes the display device 3 to display a display screen illustrated in FIG. 11. It is assumed that the function f outputs a probability of bankruptcy here, and the d types of feature values here include at least three types of feature values of “annual income”, “liabilities”, and “health state”.

In this case, the display control unit 17 acquires, as the calculation result of the route γ, values of the “annual income”, the “liabilities”, and the “health state” when the parameter t is 0 to 1 from the route calculation unit 16, and displays the acquired values as graphs. Here, the display control unit 17 displays the graph representing a transition from the value in the input case to the value in the modified case for each of the “annual income”, the “liabilities”, and the “health state”.

The display control unit 17 may display graphs for some (that is, a smaller number than the d types) of the d types of feature values instead of displaying graphs for all the d types of feature values. For example, the display control unit 17 may display a graph of a type of feature value specified by a user by the input device 2, or may display a graph of a predetermined type of feature value specified in advance.

The display control unit 17 calculates the probability of bankruptcy when the parameter t is 0 to 1 based on the function f serving as the prediction model of the probability of bankruptcy and the feature value when the parameter t is 0 to 1, and displays a prediction result graph representing the probability of bankruptcy when the parameter t is 0 to 1 on the display screen.

In this manner, on the display screen illustrated in FIG. 11, the display control unit 17 displays the information representing the transition from the input case to the modified case of each feature value and the prediction result of the prediction model as the information related to the determined route γ. As a result, the display control unit 17 can present the transition of each feature value and the prediction result of the prediction model up to the modified case that is a goal to the user.

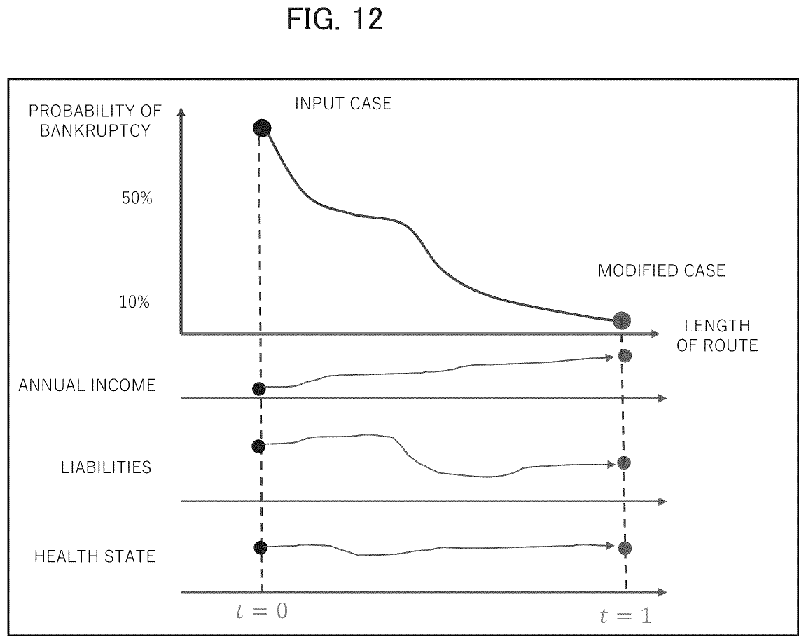

FIG. 12 is a second display example representing the calculation result of the route γ displayed on the display device 3 by the display control unit 17. In this example, the route calculation unit 16 calculates the shortest route γ related to the Riemannian metric by providing the constraint condition related to the change in the feature value according to Expression (9) or (11), and the display control unit 17 generates the display information based on the calculation result of the route γ. The display control unit 17 then supplies the generated display information to the display device 3 to cause the display device 3 to display a display screen illustrated in FIG. 12.

In this case, as a result of calculating the shortest route γ related to the Riemannian metric by providing the constraint condition related to the change in the feature value according to Expression (9) or (11), a variation in the value of each of the “annual income”, the “liabilities”, and the “health state” is smaller than that in the example of FIG. 11. In this manner, by providing the constraint condition related to the change in the feature value according to Expression (9) or (11), it is possible to calculate the sparse route related to the change from the input of the feature value and present the route to a user.

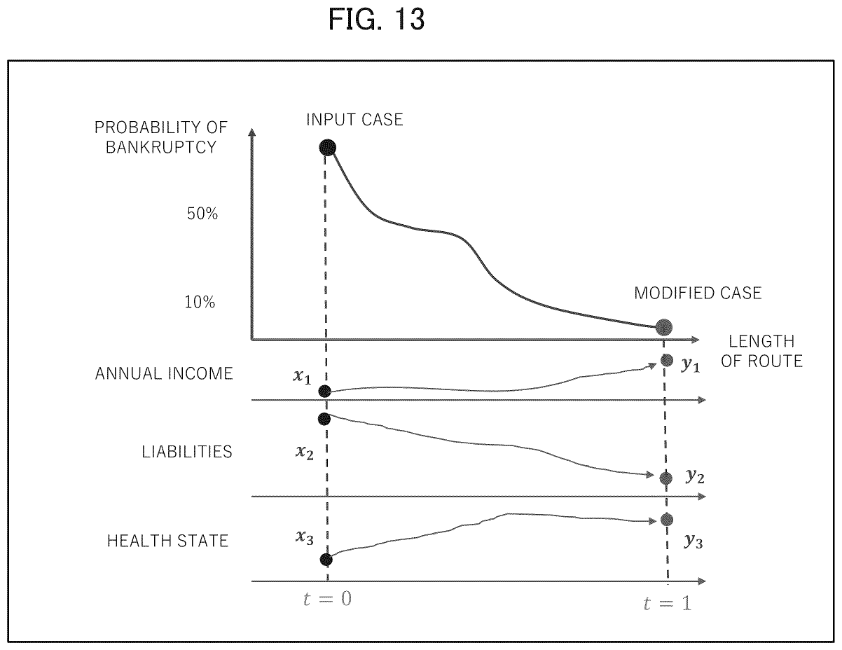

FIG. 13 is a third display example representing the calculation result of the route γ displayed on the display device 3 by the display control unit 17. In this example, the route calculation unit 16 calculates the shortest route γ related to the Riemannian metric by providing the constraint condition related to the gradient of the route γ according to Expression (13) or (16), and the display control unit 17 generates the display information based on the calculation result of the route γ. The display control unit 17 then supplies the generated display information to the display device 3 to cause the display device 3 to display a display screen illustrated in FIG. 13.

In this case, as a result of calculating the shortest route γ related to the Riemannian metric by providing the constraint condition related to the gradient of the route γ according to Expression (13) or (16), the number of feature values varying according to the parameter t is smaller than that in the example of FIG. 11. In this manner, by providing the constraint condition related to the gradient of the route γ according to Expression (13) or (16), it is possible to calculate the sparse route γ related to the gradient and present the route γ to a user.

### Second Example Embodiment

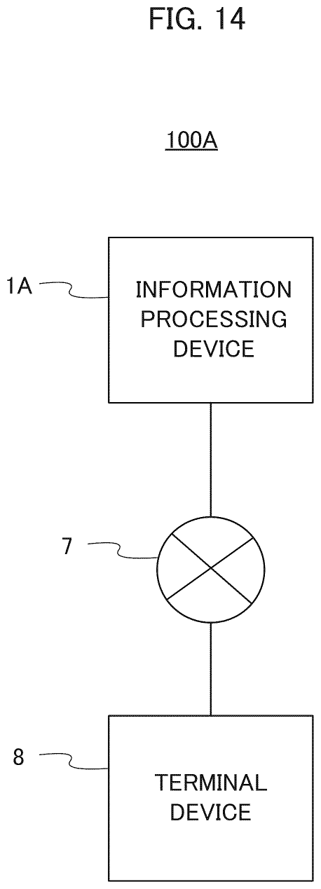

FIG. 14 illustrates a configuration of the information processing system 100A. The information processing system 100A mainly includes an information processing device 1A and a terminal device 8. The information processing device 1A and the terminal device 8 performs data communication with each other via the network 7.

The information processing device 1A is one or more devices configured to function as a server (including a cloud server) to perform information process which was executed by the information processing device 1 according to the first example embodiment. In this case, the information processing device 1A receives the input information, which was provided by the input device 2 to the information processing device 1 according to the first example embodiment, from the terminal device 8 via the network 7. The information processing device 1A transmits the display information which was transmitted to the display device 3 by the information processing device 1 according to the first example embodiment, to the terminal device 8 via the network 7.

The terminal device 8 is a terminal equipped with an input function, a display function, and a data communication function and functions as the input device 2 and the display device 3 according to the first example embodiment. Examples of the terminal device 8 include a personal computer, a tablet, and a PDA (Personal Digital Assistant). The terminal device 8 transmits the input information generated through the user input to the information processing device 1A via the network 7. Upon receiving display information from the information processing device 1A, the terminal device 8 display information using the display information.

The information processing device 1A according to the second example embodiment can suitably perform the input processing and the output processing, which were performed by the information processing device 1 in the first example embodiment, for the user of the terminal device 8.

### Third Example Embodiment

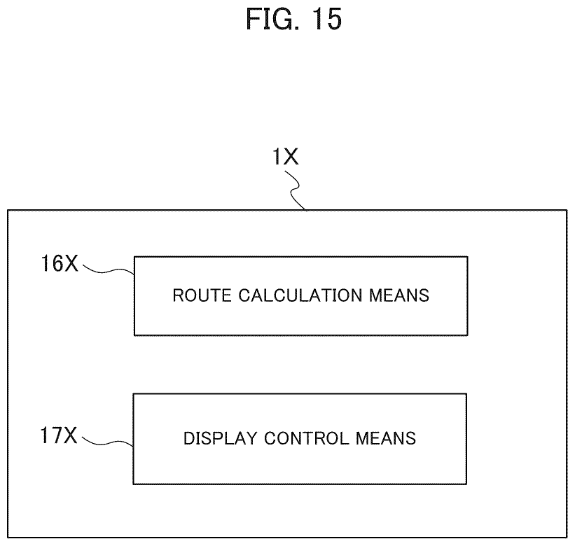

FIG. 15 is a functional block diagram of the information processing device 1X. The information processing device 1X mainly includes a route calculation means 16X and a display control means 17X. The information processing device 1X may be the information processing device 1 according to the first example embodiment or the information processing device 1A according to the second example embodiment.

The route calculation means 16X is configured to determine, from first information representing a feature value of a first event and second information representing the feature value of a second event different from the first event, a route from the first information to the second information in such a way that an evaluation value obtained by evaluating complexity of the route decreases. It is herein noted that the lower the evaluation value is, the better the evaluation becomes. Examples of the route calculation means 16X include the route calculation unit 16 according to the first or the second example embodiment.

The display control means 17X is configured to display information related to the determined route on a display device. Examples of the display control means 17X include the display control unit 17 according to the first or the second example embodiment.

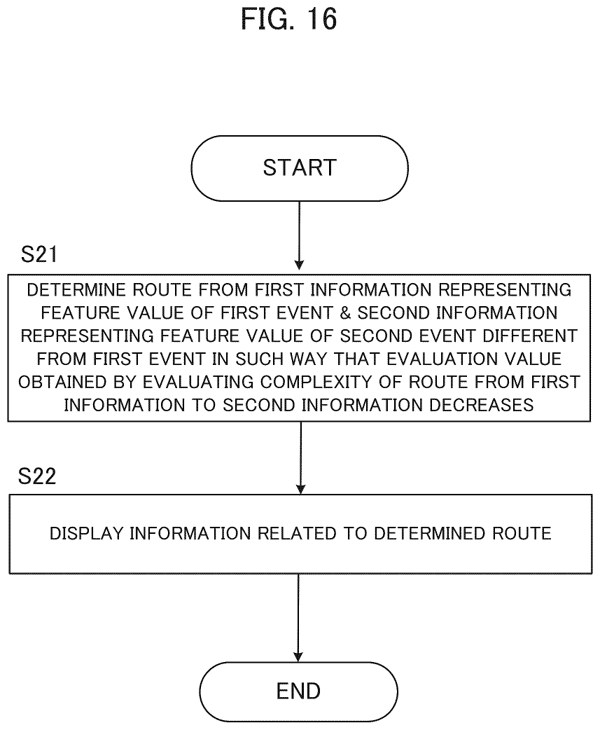

FIG. 16 is an example of the flowchart executed by the information processing device 1X. The route calculation means 16X determines, from first information representing a feature value of a first event and second information representing the feature value of a second event different from the first event, a route from the first information to the second information in such a way that an evaluation value obtained by evaluating complexity of the route decreases (step S21). Next, the display control means 17X displays information related to the determined route on a display device (step S22).

The information processing device 1X according to the third example embodiment can determine an appropriate route from the first information to the second information to display information on the determined route.

### Fourth Example Embodiment

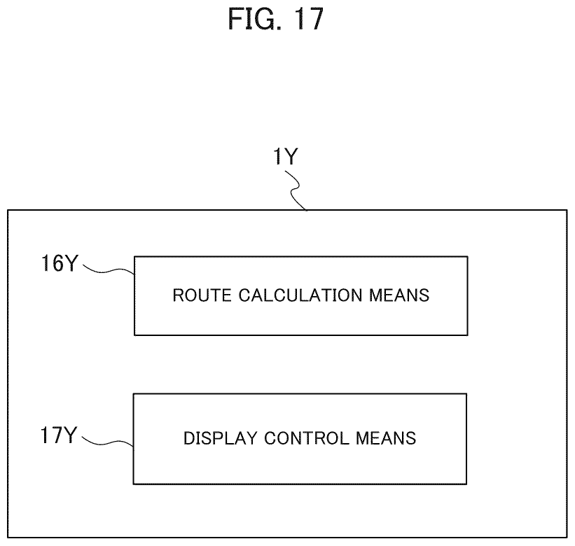

FIG. 17 is a functional block diagram of the information processing device 1Y. The information processing device 1Y mainly includes a route calculation means 16Y and a display control means 17Y. The information processing device 1Y may be the information processing device 1 according to the first example embodiment or the information processing device 1A according to the second example embodiment.

The route calculation means 16Y is configured to determine, from first information representing a feature value of a first event and second information representing the feature value of a second event different from the first event, a route from the first information to the second information in such a way that an evaluation value obtained by evaluating energy of the route decreases. It is herein noted that the lower the evaluation value is, the better the evaluation becomes.

Examples of the route calculation means 16Y include the route calculation unit 16 according to the first or the second example embodiment.

The display control means 17Y is configured to display information related to the determined route on a display device. Examples of the display control means 17Y include the display control unit 17 according to the first or the second example embodiment.

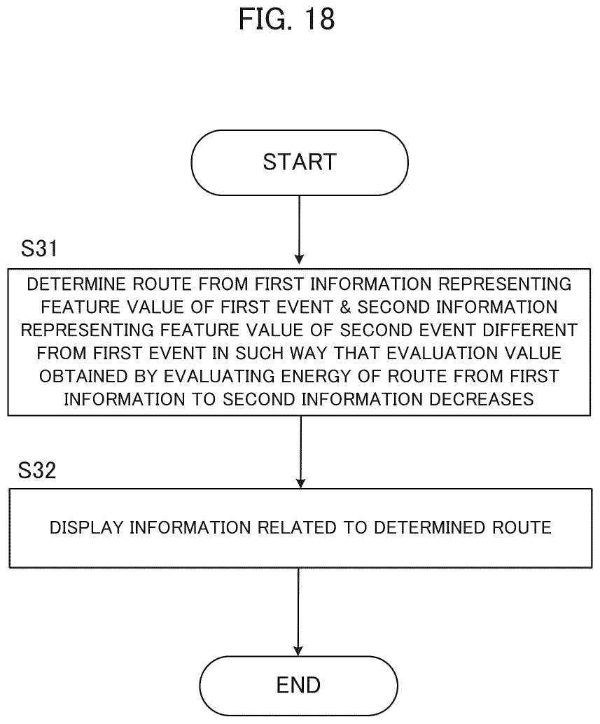

FIG. 18 is an example of the flowchart executed by the information processing device 1Y. The route calculation means 16Y determines, from first information representing a feature value of a first event and second information representing the feature value of a second event different from the first event, a route from the first information to the second information in such a way that an evaluation value obtained by evaluating energy of the route decreases (step S31). Next, the display control means 17Y displays information related to the determined route on a display device (step S32).

The information processing device 1Y according to the fourth example embodiment can determine an appropriate route from the first information to the second information to display information on the determined route.

In addition, some or all of the above-described example embodiments may also be described as following Supplementary Notes, but are not limited to the following. Furthermore, within the range defined by the above-described example embodiments, regardless of the device, method, and storage medium described in the following Supplementary Notes, some or all of the configurations described in the following Supplementary Notes may be applied to any hardware, software, system and recording means (including the storage medium) for recording a software.

### [Supplementary Note 1]

An information processing device comprising:
a route calculation means for determining, from first information representing a feature value of a first event and second information representing the feature value of a second event different from the first event, a route from the first information to the second information in such a way that an evaluation value obtained by evaluating energy of the route decreases; and
a display control means for displaying information related to the determined route on a display.

[Supplementary Note 2]

The information processing device according to Supplementary Note 1, wherein
the evaluation value is, in a coordinate space having a first axis indicative of a length related to a distance of the route and a second axis indicative of a prediction value at a point of the route, an area of a portion sandwiched between the route and the first axis in a section on the first axis from the first event to the second event, and
the route calculation means determines the route that minimizes the area.

[Supplementary Note 3]

The information processing device according to Supplementary Note 1 or 2, wherein the display control means displays information indicating a change in the feature value based on the route on the display.

[Supplementary Note 4]

The information processing device according to any one of Supplementary Notes 1 to 3, wherein the display control means displays information indicating the route in the coordinate space on the display.

[Supplementary Note 5]

The information processing device according to any one of Supplementary Notes 1 to 4, wherein the route calculation means calculates the route based on the evaluation defined based on energy of Riemannian metric in a space of the feature value.

### [Supplementary Note 6]

The information processing device according to any one of Supplementary Notes 1 to 5, wherein the route calculation means provides a constraint condition related to a change in the feature value in the route in a case where the route is calculated.

### [Supplementary Note 7]

The information processing device according to any one of Supplementary Notes 1 to 5, wherein the route calculation means provides a constraint condition related to a gradient of the route in a case where the route is calculated.

### [Supplementary Note 8]

The information processing device according to any one of Supplementary Notes 1 to 7, wherein the route calculation means provides a first constraint condition related to a change in the feature value in the route and a second constraint condition related to a gradient of the route in a case where the route is calculated.

### [Supplementary Note 9]

The information processing device according to any one of Supplementary Notes 1 to 8, wherein, upon receiving an input specifying a feature space of the feature value, the route calculation means determines the route in the feature space.

### [Supplementary Note 10]

A display method executed by a computer, comprising:
determining, from first information representing a feature value of a first event and second information representing the feature value of a second event different from the first event, a route from the first information to the second information in such a way that an evaluation value obtained by evaluating energy of the route decreases; and
displaying information related to the determined route on a display.

### [Supplementary Note 11]

A non-transitory computer readable storage medium storing a program executed by a computer, the program causing the computer to:
determine, from first information representing a feature value of a first event and second information representing the feature value of a second event different from the first event, a route from the first information to the second information in such a way that an evaluation value obtained by evaluating energy of the route decreases; and
display information related to the determined route on a display.

### [Supplementary Note 12]

A non-transitory computer readable storage medium storing a program according to Supplementary Note 11.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. Each example embodiment can be appropriately combined with other example embodiments. All Patent and Non-Patent Literatures mentioned in this specification are incorporated by reference in its entirety.

### DESCRIPTION OF REFERENCE NUMERALS

1, 1A, 1X, 1Y Information processing device
2 Input device
3 Display device
8 Terminal device
11 Processor
12 Memory
13 Interface
100, 100A Information processing system

What is claimed is:

1. An information processing device comprising:
at least one memory configured to store instructions, and
at least one processor configured to execute the instructions to:
determine, from first information representing a feature value of a first event and second information representing the feature value of a second event different from the first event, a route from the first information to the second information in such a way that an evaluation value obtained by evaluating energy of the route decreases; and
display information related to the determined route on a display.

2. The information processing device according to claim 1, wherein
the evaluation value is, in a coordinate space having a first axis indicative of a length related to a distance of the route and a second axis indicative of a prediction value at a point of the route, an area of a portion sandwiched between the route and the first axis in a section on the first axis from the first event to the second event, and
the at least one processor is configured to execute the instructions to determine the route that minimizes the area.

3. The information processing device according to claim 1, wherein the at least one processor is configured to execute the instructions to display information indicating a change in the feature value based on the route on the display.

4. The information processing device according to claim 2, wherein the at least one processor is configured to execute the instructions to display information indicating the route in the coordinate space on the display.

5. The information processing device according to claim 1, wherein the at least one processor is configured to execute the instructions to calculate the route based on the evaluation defined based on energy of Riemannian metric in a space of the feature value.

6. The information processing device according to claim 1, wherein the at least one processor is configured to execute the instructions to provide a constraint condition related to a change in the feature value in the route in a case where the route is calculated.

7. The information processing device according to claim 1, wherein the at least one processor is configured to execute the instructions to provide a constraint condition related to a gradient of the route in a case where the route is calculated.

8. The information processing device according to claim 1, wherein the at least one processor is configured to execute the instructions to provide a first constraint condition related to a change in the feature value in the route and a second constraint condition related to a gradient of the route in a case where the route is calculated.

9. A display method executed by a computer, comprising:
determining, from first information representing a feature value of a first event and second information representing the feature value of a second event different from the first event, a route from the first information to the second information in such a way that an evaluation value obtained by evaluating energy of the route decreases; and
displaying information related to the determined route on a display.

10. A non-transitory computer readable storage medium storing a program executed by a computer, the program causing the computer to:
determine, from first information representing a feature value of a first event and second information representing the feature value of a second event different from the first event, a route from the first information to the second information in such a way that an evaluation value obtained by evaluating energy of the route decreases; and
display information related to the determined route on a display.
